(19) United States
(12) Patent Application Publication
(10) Pub. No.: US 2007/0228077 A1
(43) Pub. Date: Oct. 4, 2007

(54) LOW PROFILE PUMP AND LID ASSEMBLY FOR A STACKABLE CONTAINER

(75) Inventors: Paul A. Nolte, Memphis, TN (US); Bruce Cleveland, Germantown, TN (US); Harley Thordson, Hernando, MS (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: FLOWSERVE MANAGEMENT COMPANY, Irving, TX (US)

(21) Appl. No.: 11/692,489

(22) Filed: Mar. 28, 2007

Related U.S. Application Data
(60) Provisional application No. 60/787,075, filed on Mar. 29, 2006.

(51) Int. Cl. B67D 5/60

(52) U.S. Cl. 222/143

(57) ABSTRACT

A pump and tank lid assembly. The pump is of a low-profile, lightweight design to enable it to cooperate with the lid so that a relatively thin-walled tank can support its weight. In addition, the low-profile design allows the pump to remain attached to the top of the tank, even during shipping and stacking of the tanks. Projections formed either in the tank or on a frame that surrounds the tank extend beyond the dimensions of the pump. The projections allow stacking of fluid material containing tanks so that during tank stacking, adequate clearance is formed between the top of the pump in a lower tank and the bottom of an upper tank.

This application claims the benefit of the filing date of U.S. Provisional Application No. 60/787,075, filed Mar. 29, 2006.

### BACKGROUND OF THE INVENTION

This invention relates generally to a pump mounted to the lid of a tank, and more particularly to a low profile pump that cooperates with a tank lid to allow withdrawal of a fluid material in a tank from the top of the tank, as well as the ability to stack tanks without the removal of the pump.

It is common practice today to ship fluid materials (such as flowable or granular solids, liquids or the like) in 120 to 200 gallon shipping containers known as totes, mini-bulk tanks, or intermediary bulk containers (IBCs), collectively referred to as tanks or containers. The typical tank will have a filling port or lid on top (usually an eight-inch diameter opening), and a two-inch bunghole for mounting apparatus and/or a bottom dispensing port for draining. A pump is typically mounted to either the bunghole or the filling port, and in a typical application, these pumps are used to empty tanks in the field. A significant amount of agricultural liquid-storage containers utilize top-mounted pumps to transport fertilizers, insecticides or the like. Such tanks can also be used in the industrial market to transport other bulk fluids such as soap, oils, bleach, ink or the like.

Recently, these tanks have been equipped with an external frame; such “bird cage” tank styles provide enhance tank rigidity that facilitates tanks support and shipping. Unfortunately, this style of tank makes it difficult to accept top-mounted pumps. In another recent development, inexpensive and lightweight tanks with thin flexible plastic walls have been introduced to the market. The construction of such tanks makes it difficult and expensive to mount or install a top connected pumping system. In one typical configuration, a pump is mounted on the bottom discharge valve to empty the contained fluid. Bottom withdraw pumps have problems due to their large size, limited floor space and risk of leaking. In addition, having to disconnect the pump and its ancillary equipment in order to stack or move tanks presents a significant inconvenience to the user or operator.

An alternative is to mount the pumps using a modified tank lid. In one approach, a hole can be cut into the lid, where the pump is held in place on top of the tank with a jam nut or related locking mechanism. This method is limited to tanks only with large enough lids capable of fitting the flange on the pump housing. A second approach is to place a port into the lid (similar to the aforementioned bunghole) and mount the pump using standard piping methods. Both of these mounting approaches have potential problems. First, a high pump profile above the tank frame increases the volume of the tank, thereby reducing stacking efficiency. Second, the mounting allows for an increased number of potential leak paths. Third, the tank must have a large enough lid to accept the pump flange.

In yet another alternative configuration, multi-walled tanks have been employed, especially for use with tanks for hazardous material storage, transport and dispensing. In such construction, an outer tank can be made to conformally fit around an inner tank to protect the latter from, inter alia, shipping and handling damage. Such features, while useful for their intended purpose, significantly add to the cost, weight and complexity of the tank, which is disadvantageous for totes, mini-bulk tanks or IBCs, especially when such are configured as containers that can be disposed of after one (or only a few) uses.

Examples of pumps that may be useable in the aforementioned applications are described in detail in other patents owned by the Assignee of the present invention, including U.S. Pat. Nos. 4,557,669 (describing the pump and working mechanism thereof), 4,570,833 (describing a closed system pumping design), 4,685,592 (describing a closed system that has a rinsing device), 5,450,987 (describing a spring-loaded safety valve located in the discharge valve of the pump, a feature that will be utilized in the present invention), and 5,366,351 (describing an automatic shutoff valve for a pump and motor), all hereby incorporated by reference.

In another entirely different configuration, a pump assembly may include a flange that is mounted to the tank using a tank lid with a large hole cut out. A disadvantage with such design is that the assembly is heavy, making it difficult for the relatively thin tank walls to support its weight. Another disadvantage is that the pump possesses a relatively tall profile, thereby taking up more space than necessary and impeding tank stacking. What is desired is a pump and lid combination that takes up less weight and volume than conventional approaches.

### SUMMARY OF THE INVENTION

These desires are met by the present invention, wherein a pump and a method of operating the pump that incorporates the features discussed below is disclosed. According to a first aspect of the invention, a stackable container assembly is disclosed. The assembly includes a tank for containing a fluid material therein and a pump coupled to the tank. The tank includes a bottom section, top section and intermediate section that together make up a fluid material container. The pump is coupled to the tank at the top section, and is sized and shaped such that the pump can easily fit onto an existing lid mount. More particularly, the pump defines a low-profile form such that it occupies a volume that does not extend beyond dimensions defined by tank structure at the upper end of the tank. Together, the assembly formed by the pump and tank coupled together allows the pump to remain attached to the tank, even during container transport and storage.

Optionally, the pump has an integral housing which has threads that cooperate with complementary threads formed on the top of the tank. Thus, by simple screwing and unscrewing operations, the pump can be easily mounted and dismounted from the tank. In another particular configuration, the pump and the tank are removably connected to one another through simple mounting means (such as wing nuts or other such fasteners that do not require little or no tool use) such that the pump can be easily detached from the tank. In a more particular form, the pump is connected to the tank through one or more screws that can be engaged or disengaged without the use of tools. Ancillary components used to support pump functions (such as power supplies, fluid material conduit or the like) may be configured such that they either do not extend heightwise beyond the dimensions established by the pump or can be readily separated therefrom.

In one form, the tank is made up of a plastic material. In a particular option, the intermediate section is made up of numerous lateral walls, where the tank can define, for example, a generally rectangular cross-section. In a particular configuration, the top section is formed as a lid that is selectively attachable to the tank intermediate section. Projections (discussed below) formed into or cooperative with the tank may define a volumetric space that extends above or below the fluid material-containing portions of the tank. These projections (as well as complementary recesses configured to accept such projections) may make up stacking members that may include nesting attributes to promote a more secure connection between stacked tanks. The additional space created by the presence of the projections allows a heightwise clearance distance between the top section of the tank (also referred to as a first tank) and a bottom section of a second tank that can be stacked upon the first tank so that the bottom section of the second tank does not form an interference fit with the pump that is situated on the top of the first tank. For example, the pump coupled to the top section defines a heightwise dimension that is less than the heightwise clearance distance between the first and second staked tanks.

The assembly may also be equipped with a frame disposed substantially about the tank to increase the tank rigidity. Numerous stacking members may be formed into the upper and lower surfaces of the frame such that upon stacking of one of the frames onto another, surface features formed into the upper surface of the lower one of the stacked frames may cooperatively engage the surface features formed into the lower surface of the upper one of the stacked frames. In configurations where no frames are used, such that stacking is between upper and lower tanks directly, the stacking members may be formed directly into the top and bottom sections of the tank. In this way, when the tank is stacked upon another generally similar tank, the stacking members formed into the top section of the lower tank cooperatively engage the stacking members formed into the bottom section of the upper tank. In either form of such an assembly, the stacking members formed into the bottom section may define substantially downward-projecting legs, while the stacking members formed into the top section comprise a plurality of substantially upward-projecting arms. Shaping, tapering or sizing between the arms and legs may contribute to nesting features that can be exploited to facilitate a secure fit between them. In another configuration, either of the top or bottom section may instead include recesses (rather than projections) formed to allow cooperation between adjacently-placed stacked tanks. For example, a first tank may have upwardly-projecting arms extending from the top section so that when a second tank is stacked onto the first tank, the recesses formed in the bottom section of the second tank and the upward-projecting arms of the top section of the first tank may be nested, thereby reducing the tendency of the two tanks to move laterally relative to one another.

Such a configuration will make it easy to mount the pump to existing tanks, many of which have a standardized lid with a threaded connection. For example, the connection may be formed from a six inch (or other conveniently-sized) diameter. As stated above, the fluid material-containing part of the tank may be made from a thin-walled plastic tank that may or may not be strengthened by a metal frame to improve lifting, transportation and stacking of the tank.

In one embodiment, the coupling of the pump and the lid is done in such a way that the pump remains with the lid through the life of the container. The container, while capable of being reused, may be disposable. In such case, the pump needs to be inexpensive enough that it too can be thrown away with the tank and lid. The coupling of the pump to the lid can thus be of a permanent or semi-permanent nature, such that the pump and lid form a single component. A key benefit of having the pump and lid as one component is a low profile which does not rise above the tank's surrounding frame. This allows the ability of stacking one tank on top of another without having to go through the time-consuming process of removing the pump. This is especially valuable where large numbers of containers are being used or stored in a common location, so that floor storage space is best utilized.

The pump is configured to be removably attached to a discharge port (which may be in the form of an elbow or related bend), a motor used to turn the pump, and a switch used to turn the pump on and off. This allows safe transporting of the tank while maintaining the original low profile of the pump and lid assembly. One or more particular features may be included in the pump. For example, the pump may have an internal valve that closes upon removal of the discharge elbow. This prevents leaks during transportation, especially for situations where the user does not install a secondary rain lid. The pump may also include an integral venting port and cover; these can be removed to allow air to enter the tank as the fluid is removed during pumping off of the fluid, thereby preventing tank collapse. By keeping the pump and lid assembly lightweight, no secondary support during transportation is required.

According to another aspect of the invention, a stackable tank is disclosed. The tank includes a fluid container portion, a stacking portion, a lid cooperative with the fluid container portion and a pump coupled to the lid. The stacking portion extends a heightwise clearance distance beyond the fluid container portion, and defines a heightwise dimension that is less than the heightwise clearance distance such that upon stacking of two or more of the tanks, the pump on a lower one of the tanks does not interfere with an adjacent surface on an upper one of the tanks. The stacking portion may be made up of stacking members, such as the aforementioned arms, legs and recesses, all of which can be integrally formed into one or more surfaces of the tank.

According to another aspect of the invention, a method of stacking fluid material containers is disclosed. The method includes securing a pump to a generally upper surface of one or more fluid material containers, providing a stacking portion to the container such that the stacking portion extends a heightwise clearance distance that is greater than a heightwise dimension defined by the pump, and stacking the containers such that an upper container does not form an interference fit with the pump that is part of a lower container.

Optionally, stacking members are formed on one or both of upper and lower surfaces of the fluid material containers. In this way, the stacking members from the upper surface of the lower stacked container are substantially complementary with the stacking members from the lower surface of the upper stacked container. By placing the stacking members from the lower one of the stacked containers into cooperative arrangement with the stacking members from the upper one of the stacked containers, a more secure fit between the stacked containers is formed. In a particular form, the stacking members make up the stacking portion of the container. In another particular form, the stacking portion is integrally formed (such as by molding or other approaches that would result in a substantial unitary structure) into its corresponding fluid material container. In another form, a frame can be included to enhance the container. In this way, the stacking portion may be formed as part of the frame, or may be formed as part of the container directly and made to extend beyond the frame. In situations where the stacking members form part of a frame that is attachable to or otherwise structurally cooperative with the tank, such stacking members may also include lateral support in the form of webs, ties or other structure that maintains lateral spacing among the legs, arms or other vertically engaging components of the stacking members.

Other features and advantages of the invention will be apparent from the following description, the accompanying drawings and the appended claims.

### BRIEF DESCRIPTION OF THE SEVERAL VIEWS OF THE DRAWINGS

The following detailed description of the present invention can be best understood when read in conjunction with the following drawings, where like structure is indicated with like reference numerals and in which:

FIG. 1 is an elevation view of a pump attached to a tank lid according to the prior art;

FIG. 2 is an elevation view of an embodiment of the pump and lid assembly of the present invention;

FIG. 3 is a view of the pump of FIG. 2, shown removed from the lid of the tank;

FIG. 4 shows the pump and lid assembly of FIG. 2 on top of a tank, with a second tank stacked on top of the first;

FIG. 5 shows a detail view of the low profile nature of the pump and lid assembly of FIG. 4, and how it does not interfere with the lower part of the frame of the second tank;

FIG. 6 shows various views of the pump and lid assembly of FIG. 2, now also showing the inclusion of a motor, switch and discharge port; and

FIG. 7 shows a pair of tanks according to an aspect of the present invention being stacked on top of one another.

### DETAILED DESCRIPTION

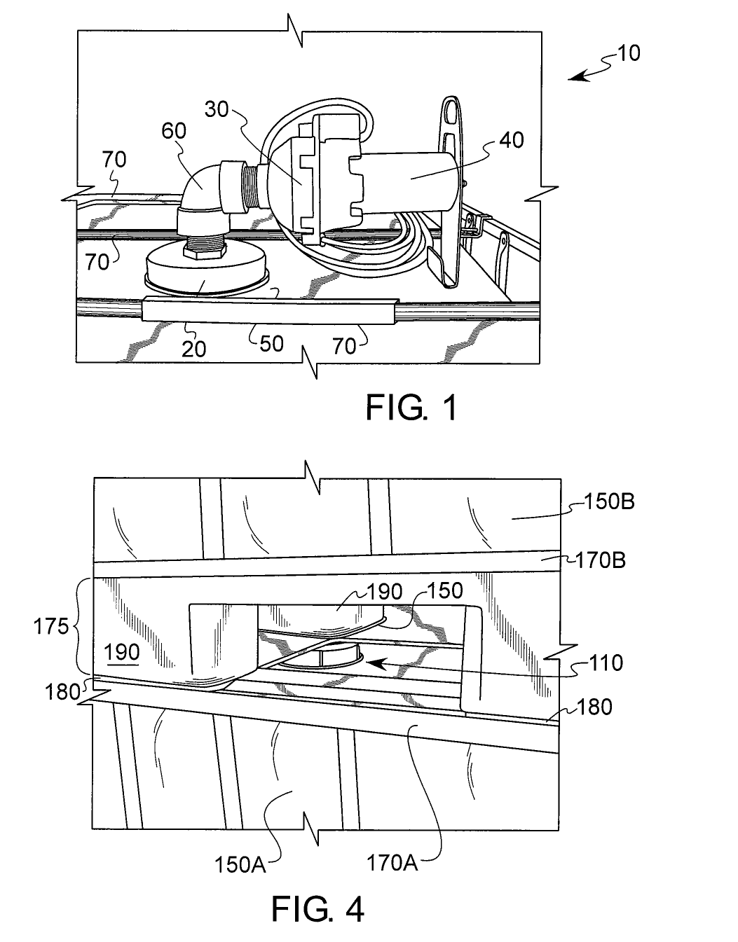

Referring first to FIG. 1, an assembly for a pump 10 connected via lid 20 to the top of a tank 50 according to the prior art is shown. The configuration is such that an aperture or port (not shown) in the top of tank 50 allows fluid communication between the pump 10 and the tank 50. The pump 10 includes a pumping device (not shown) enclosed in a housing 30 and a motor 40. Suction elbow 60 connects the pump 10 and lid 20. A frame 70 can be used to provide structural rigidity to tank 50. As can be seen, the vertical profile of pump 10 is such that it projects above the top of tank 50 so that if multiple tanks 50 were to be stacked one on top of the other, pump 10 would have to be removed to avoid damage to the pump 10, lid 20 or both.

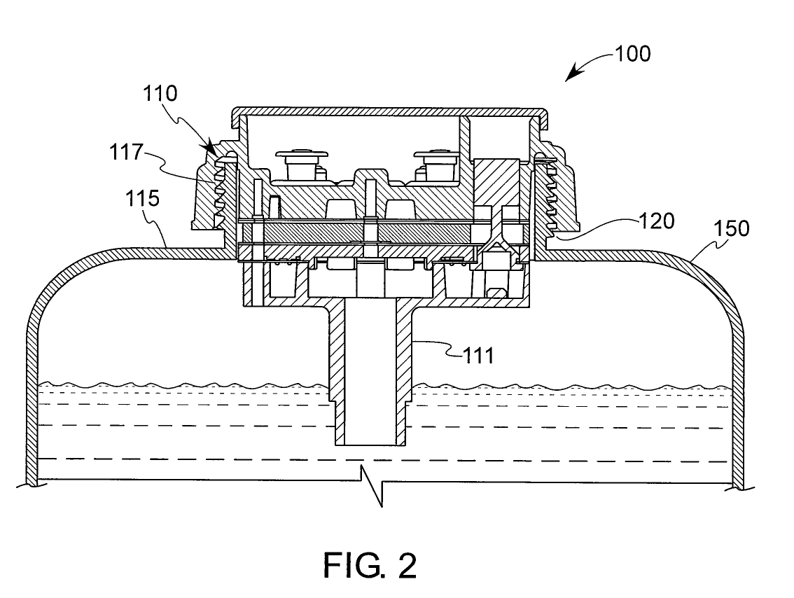

Referring next to FIGS. 2 through 7, a pump and lid assembly 100 according to an aspect of the present invention is shown. The assembly 100 includes a pump 110 and lid 120. In the present disclosure, the terms “lid” and “top” are used interchangeably, and any ambiguity will be resolved by reference to the context in which each term is used. As shown, lid 120 is integrally formed into the uppermost part of tank 150 such that it functions as the top thereof. In such configuration, the tank 150 is of one-piece design, and can be manufactured by methods known in the art, such as blow molding, rotational molding or the like. In another form (not shown), the lid 120 may be separately formed from the remainder of the tank 150 such that the two can be attached (through conventional securing means understood by those skilled in the art). Such a separate construction could be especially compatible with configurations where the pump 110 and lid 120 are connected as part of a unitary structure. In this latter configuration, connection or fastening between the lid 120 and the tank 150 can be established by approaches well-known in the art.

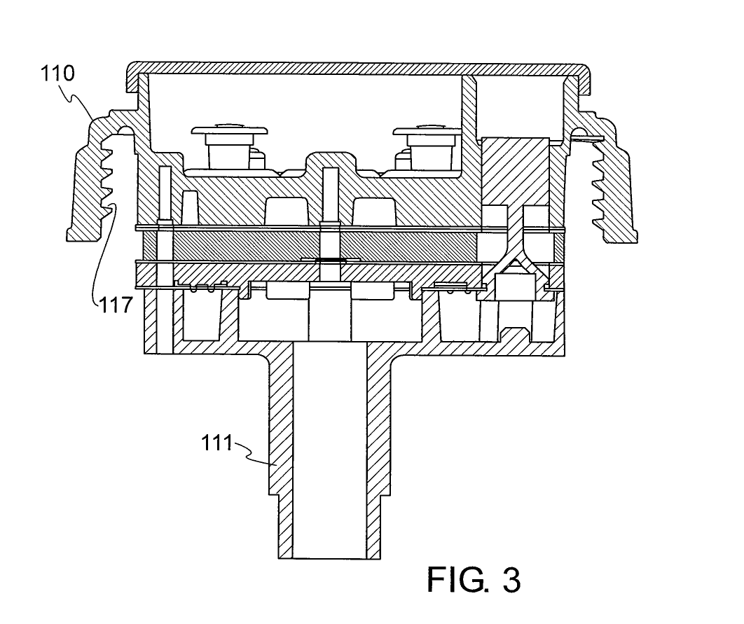

As shown with particularity in FIGS. 2 and 3, a threaded connection 117 between the pump 110 and the lid 120 promotes a secure connection between the two, although it will be appreciated by those skilled in the art that other connection schemes may be used. A pump inlet 111 extends downward from the bottom of pump 110 into tank 150. By eliminating the elbow 60 and reorienting the pump 110, as well as placing at least a portion thereof below the top of tank 150, the overall profile of the assembly 100 can be significantly reduced. FIG. 3 shows the lid 120 removed for clarity to better show the threaded connection 117 formed as an outer flange of pump 110.

Referring next to FIGS. 4 and 7 in conjunction with FIG. 2, one benefit of the tank configuration of the present invention is the ability of the tanks 150 (shown individually as a lower tank 150A and upper tank 150B) to be stacked, thereby improving storage and shipping efficiency. As can be seen, the pump 110 is sized to fit with the lid 120 such that the pump 110 has a low vertical profile to avoid interference with the surface of an adjacently stacked tank. In addition, the pump 110 is secured to the lid 120 (such as by the threaded connection 117 discussed above) so that when not pumping the fluid material inside the tank 150, the pump 110 acts as a cap surrogate to prevent spillage of the fluid material from the tank 150. By having the pump 110 be top-mounted, leakage and storage problems associated with bottom-mounted pumps are avoided.

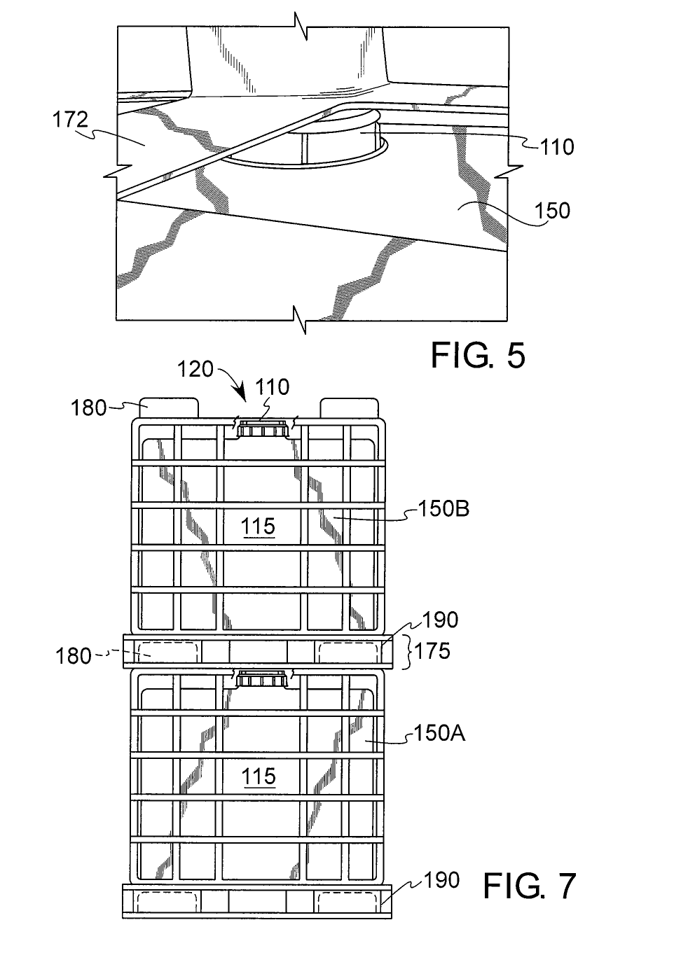

Stacking members 175 can be used to align and stackedly couple lower tank 150A and upper tank 150B. Stacking members may be formed as part of frame 170, or may be formed as a separate components that, like a tray, pallet or related support, may be used to effect the stacking between vertically adjacent tanks 150A, 150B. The low-profile nature of the pump 110, coupled with stacking members 175 formed with downwardly-projecting legs 190 and complementary-shaped arms 180 allow nested cooperation and secure stacking of two or more of the tanks 150A, 150B. In the construction depicted in FIGS. 4 and 7, as well as partially depicted in FIG. 5), the stacking member 175 is placed above, below or both above and below a tank to which it attaches. Nesting components (such as arms 180 and legs 190) are either formed separately from and attachable to the frame 170, or can be made as a part thereof. When made separately from the frame 170, the stacking member 175 (and its attendant nesting components) can be formed from a single piece of moldable material, such as a plastic. In a separate construction (not shown), where the stacking members are integrally formed into one or both of tank upper and lower surfaces, the downwardly-projecting legs 190 may extend from a lower surface of an upper tank 150B and complementary-shaped arms 180 may extend from an upper surface of a lower tank 150A. In such integral formation, the stacking members and tanks may be made from a plastic-based material.

In one form, the tank 150 and pump 110 are readily separable from one another such that either or both may be reused. Even in situations where the pump 110 can be removed from the tank 150, the low profile nature of the assembly 100 is such that the pump 110 can be left in place during shipping to reduce the time and complexity associated with transport of both. In an optional form, the tank 150 and pump 110 can be made of low-cost material and manufacturing methods such that the pump 110 may be integrally-formed with the tank 150 or lid 120, allowing both to be disposed of upon dispensing of the fluid material contained therein.

Each tank 150 includes numerous lateral (i.e., side) walls 115, a lid (or top) 120 and bottom 125. The lid 120 can be integrally formed such that it forms a continuous upward extension of the side walls 115. As can be seen, the tanks 150A, 150B include the stacking members 175 made up of arms 180 and legs 190. These projections (i.e., the arms and legs 180, 190) allow complementary engagement that make up the stacking members 175, and may be separate components (as shown in FIGS. 4 and 7) or molded into or otherwise formed into the appropriate top or bottom of the tank 150 to allow secure placement of one tank into another in stacked relationship, both as discussed above. The arms and legs 180, 190 define a stacking portion that extends a distance beyond (either above or below, depending on the orientation of the tank 150) the portion of the tank 150 that contains the fluid material. This extension is of sufficient dimension (such as depth) that the uppermost part of pump 110 does not touch an adjacent surface of upper tank 150B that is stacked on top of the lower tank 150A. This is beneficial in that the pump 110 need not be removed from tank 150A while the tanks 150A, 150B are stacked. As can be seen with particularity in FIGS. 4 and 5, connecting structure (in the form of webs 172, discussed below) can be used to provide structural coupling between adjacent arms 180 or legs 190.

Referring with particularity to FIG. 7, tank 150 is relatively thin-walled, and therefore may include a substantially rectangular frame 170 which can be sized and configured such that it forms with or around the tank 150 to promote structural rigidity of the tank 150, as well as provide the stacking members 175 and other stacking-enhancement features. In the alternate configuration, the arms 180 and legs 190 of the stacking member 175 may be formed as part of the tank 150. In the configuration where the stacking members 175 are formed as part of frame, the tank 150 can be made of a more conventional shape, such as rectangular, cylindrical or the like. Although not shown, ridges or related protuberances can be formed in the lateral walls 115, bottom walls 125 or other parts of tank 150 in order to enhance its rigidity.

As shown with particularity in FIG. 4, a lower tank 150A and upper tank 150B are in a stacked arrangement, where pump 110 is placed on top of lower tank 150A. It can be seen that the low profile nature of pump 110 allows it to fit underneath the lower portion of frame 170B (that is used to provide rigidity to upper tank 150B) in such a way that the pump 110 does not come in contact with frame 170B. This promotes stacking and related transport without having to remove pump 150. Specifically, connecting structure 172, shown presently as a thin horizontal web that extends between arms 180 (only a tiny vertical portion of which is seen extending out of the bottom of leg 190 with which it is nested), may form part of the stacking member 175 or frame 170A or 170B.

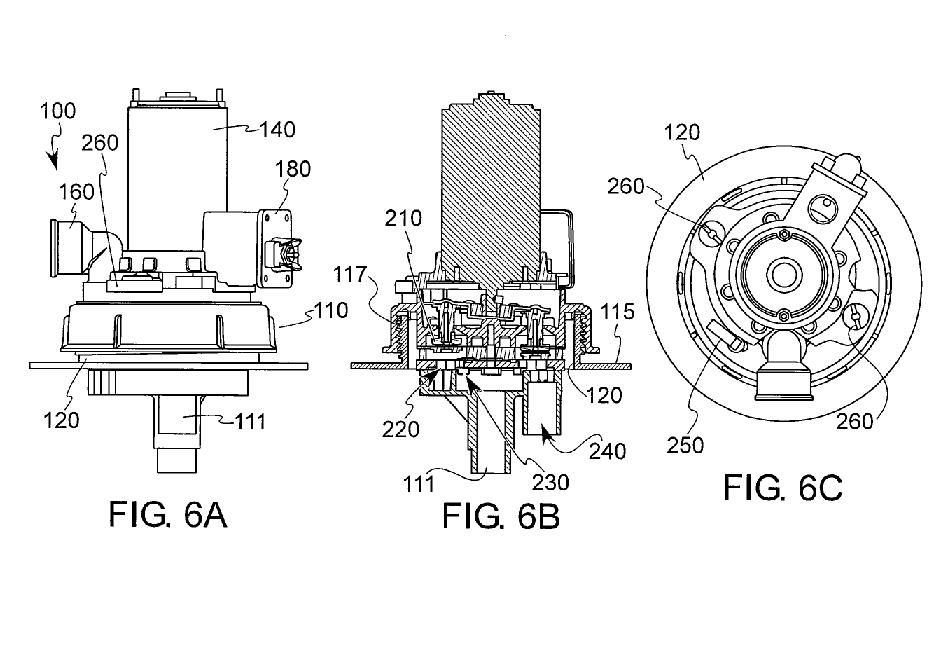

Referring next to FIGS. 6A through 6C, various views of the pump 110 and lid 120 connected together as an assembly 100 are shown with removable ancillary pump components, including motor 140, discharge port 160 and switch 180. As with the connection of the pump 110 to the lid 120, these components can be secured to the pump and lid assembly 100 with a small number (for example, two) wing nuts 260 or related fasteners, thereby allowing the removable components to be taken off prior to storage or stacking of tank 150. In a preferable form, such attachment and removal is a tool-less operation. By having readily-detachable features, the motor 140 and other ancillary components can be reused. The cutaway view of FIG. 6B highlights some of the internal mechanisms of the pump 110, including the pump pistons 210 that are cooperative with outlet valves 220 and inlet valves 230, bypass valve 240 that dispenses into the tank 150. A tank vent 250 is shown in FIG. 6C to allow vapor to escape, thereby preventing an overpressure in the tank 150.

Having described the present invention in detail and by reference to the embodiments thereof, it will be apparent that modifications and variations are possible without departing from the scope of the invention in the following claims.

What is claimed is:

1. A stackable container assembly comprising:
a tank comprising:
a bottom section defining a generally lower surface;
a top section defining a generally upper surface and at least one fluid material access port therein; and
an intermediate section disposed between said bottom and top sections; and
a pump coupled to said top section and defining a heightwise dimension that is less than a heightwise clearance distance between said top section of said tank and a bottom section of another tank stacked upon said tank such that said bottom section of said another tank does not interfere with said pump.

2. The assembly of claim 1, wherein said tank comprises a plastic material.

3. The assembly of claim 2, wherein said bottom, intermediate and top sections form a one-piece structure.

4. The assembly of claim 1, wherein said fluid material access port and said pump comprise complementary threaded surfaces to secure said pump to said tank.

5. The assembly of claim 1, wherein said intermediate section comprises a plurality of lateral walls.

6. The assembly of claim 5, wherein said tank defines a generally rectangular cross-section.

7. The assembly of claim 1, further comprising a frame disposed substantially about said tank to increase the rigidity thereof.

8. The assembly of claim 7, further comprising a plurality of stacking members formed by upper and lower surfaces of said frame such that upon stacking one said assembly onto another said assembly, said stacking members formed into said upper surface of a lower one of said stacked assemblies cooperatively engage said stacking members formed into said lower surface of an upper one of said stacked assemblies.

9. The assembly of claim 1, further comprising a plurality of stacking members formed into said top section and said bottom section of said tank such that upon stacking said another tank onto said tank, said stacking members formed into said top section of said tank cooperatively engage said stacking members formed into said bottom section of said another tank.

10. The assembly of claim 9, wherein said stacking members formed into said bottom section comprise a plurality of substantially downward-projecting legs.

11. The assembly of claim 9, wherein said stacking members formed into said top section comprise a plurality of substantially upward-projecting arms.

12. The assembly of claim 11, wherein said stacking members formed into said bottom section comprise a plurality of substantially upward-projecting recesses.

13. The assembly of claim 1, wherein said top section is formed as a lid selectively attachable to said intermediate section.

14. The assembly of claim 1, further comprising fasteners configured to establish said coupling between said pump and said top section, said fasteners configured to facilitate selective attachment therebetween without the use of tools.

15. A stackable tank comprising:
a fluid container portion;
a stacking portion, said stacking portion extending a heightwise clearance distance beyond said fluid container portion;
a lid cooperative with said fluid container portion; and
a pump coupled to said lid and defining a heightwise dimension that is less than said heightwise clearance distance such that upon stacking of two or more of said tanks, said pump on a lower one of said tanks does not interfere with an adjacent surface on an upper one of said tanks.

16. A method of stacking a plurality of fluid material containers, said method comprising:
securing a pump to a generally upper surface of at least one of said plurality of fluid material containers;
providing a stacking portion to said at least one of said plurality of fluid material containers such that said stacking portion extends a heightwise clearance distance that is greater than a heightwise dimension defined by said pump; and
stacking said plurality of fluid material containers such that an upper one of said plurality of fluid material containers does not form an interference fit with said pump disposed on a lower one of said plurality of fluid material containers.

17. The method of claim 16, further comprising:
forming stacking members on at least one of an upper surface and a lower surface of each of said plurality of fluid material containers such that said stacking members from said upper surface of said lower one of said plurality of fluid material containers are substantially complementary with said stacking members from said lower surface of said upper one of said plurality of fluid material containers; and
placing said stacking members from said lower one of said plurality of fluid material containers into cooperative arrangement with said stacking members from said upper one of said plurality of fluid material containers.

18. The method of claim 17, wherein said stacking members make up said stacking portion.

19. The method of claim 16, wherein said stacking portion is integrally formed into a respective one of said plurality of fluid material containers.

20. The method of claim 16, further comprising disposing a frame about each of said plurality of fluid material containers.

21. The method of claim 20, further comprising forming said stacking portion on said frame.

22. The method of claim 20, wherein said stacking portion is integrally formed into a respective one of said plurality of fluid material containers and extends heightwise beyond said frame.
